(19) United States
(12) Patent Application Publication
(10) Pub. No.: US 2018/0124592 A1
(43) Pub. Date: May 3, 2018

(54) DISTRIBUTED DATA STORE-EQUIPPED EVOLVED PACKET CORE APPARATUS AND METHOD

(71) Applicant: Futurewei Technologies, Inc., Plano, TX (US)

(72) Inventors: Yinghua Ye, Los Gatos, CA (US); Hang Shi, Fremont, CA (US); Huida Dai, Cupertino, CA (US)

(21) Appl. No.: 15/336,698

(22) Filed: Oct. 27, 2016

(51) Int. Cl. H04W 8/08; H04L 12/66; H04L 29/08; H04L 12/715

(52) U.S. Cl. CPC H04W 8/08; H04L 12/66; H04W 84/042; H04L 45/64; H04L 67/1097

(57) ABSTRACT

A distributed data store-equipped evolved packet core (EPC) apparatus and method are provided. Included is a distributed data store configured to store user equipment (UE) information received from a mobility management entity (MME), and gateway information received from a plurality of gateway user plane services and computing resources (e.g. gateways, etc.). Gateway controllers are in communication with the distributed data store. Such gateway controllers receive a message from the MME associated with a service request for a UE. Further, in response to the message, the distributed data store is queried for at least a portion of the UE information associated with the UE, and at least a portion of the gateway information. Further, at least one gateway is identified using the gateway user plane services, based on the at least portion of the UE information and the at least portion of the gateway information, for use in servicing the service request for the UE.

### FIELD OF THE INVENTION

The present invention relates to networking, and more particularly to evolved packet core (EPC) architectures.

### BACKGROUND

Evolved packet core (EPC) in a 4G network refers to a framework for providing converged voice and data on a 4G long-term evolution (LTE) network. Typically, EPC architectures are configured to include a mobility management entity (MME), a home subscriber server (HSS), serving gateways (S-GW), and a packet data network (PDN) gateway (P-GW), where a control plane and a user plane of the S-GW or P-GW are located in the same physical box. Such same box approach, however, does not lend itself to scaling well, and time-to-market can be prohibitively long.

Recently, network function virtualization (NFV) advances have been applied to EPC architectures such that the aforementioned user plane and control plane of the relevant S-GW/P-GW are separated. In such architecture, the control planes of both the S-GW and the P-GW are, at least in part, implemented using virtualized applications. This approach may enable more flexible deployments and provide resource elasticity to meet diverse traffic demands.

With that said, various recently developed applications (e.g. virtual reality, augmented reality, self-driving vehicles, etc.) are demanding higher throughput, lower latency characteristics from mobile networks. Further, the aforementioned EPC architecture advances still rely upon a centralized data plane and a per-bearer state that are inflexible for the introduction of in-network services which, in turn, causes scaling problems and latency issues for operators of the aforementioned applications. Still yet, user equipment (UE) contexts and network states are typically stored at individual network elements. Thus, network elements can only scale based on its own data information, which may lead to suboptimal network design.

### SUMMARY

A distributed data store-equipped evolved packet core (EPC) apparatus and method are provided. Included is a distributed data store configured to store user equipment (UE) information received from a mobility management entity (MME), and gateway information received from a plurality of gateway user plane services and computing resources (e.g. gateways, etc.). Gateway controllers are in communication with the distributed data store. Such gateway controllers receive a message from the MME associated with a service request for a UE. Further, in response to the message, the distributed data store is queried for at least a portion of the UE information associated with the UE, and at least a portion of the gateway information. Further, at least one gateway is identified using the gateway user plane services, based on the at least portion of the UE information and the at least portion of the gateway information, for use in servicing the service request for the UE.

In a first embodiment, the at least one gateway may be identified via the gateway user plane services with a virtualized user plane implemented using a plurality of gateway clusters. Further, the at least one gateway may be selected based on the service request, a utilization of the gateway user plane services and/or the computing resources, and/or a location of the gateway user plane services and the computing resources.

In a second embodiment (which may or may not be combined with the first embodiment), the at least one gateway may be identified in connection with a construction of the at least one gateway using the gateway user plane services, where the gateway user plane services take a form of a virtualized user plane implemented using a plurality of gateway clusters. As an option, the at least one gateway may be constructed by applying a subset of a plurality of service blocks of the gateway user plane services.

In a third embodiment (which may or may not be combined with the first and/or second embodiments), the distributed data store may be further configured to store network information received from a programmable network. Further, the gateway controllers may be further configured to query the distributed data store for at least a portion of the network information, in response to the message. Still yet, the gateway controllers may be further configured to program the programmable network based on the at least portion of the network information, for use in servicing the service request for the UE by routing communications between the UE and the at least one gateway. As another option, the gateway controllers may be implemented utilizing a software-defined network (SDN) controller platform that is further configured to store the network information received from the programmable network. Such SDN controller platform may be further configured to program the programmable network based on the at least portion of the network information, and routing communications between the UE and the at least one gateway.

In a fourth embodiment (which may or may not be combined with the first, second, and/or third embodiments), the gateway controllers may be further configured for being addressable utilizing a single virtual Internet Protocol (IP) address. As a further option, using a load balancing mechanism, the message may be received by one of the gateway controllers based on a load of the one or more of the gateway controllers.

In a fifth embodiment (which may or may not be combined with the first, second, third, and/or fourth embodiments), the distributed data store may be updated.

In a sixth embodiment (which may or may not be combined with the first, second, third, fourth, and/or fifth embodiments), the UE information may relate to a capability of the UE, a type of the UE, a location of the UE, a quality of service associated with the service request, and/or a service associated with the service request.

In a seventh embodiment (which may or may not be combined with the first, second, third, fourth, fifth, and/or sixth embodiments), the gateway information may relate to a utilization of the gateway user plane services and/or the computing resources, and/or a location of the gateway user plane services.

In an eighth embodiment (which may or may not be combined with the first, second, third, fourth, fifth, sixth, and/or seventh embodiments), the gateway user plane services may include: a service registration module configured to register a plurality of service blocks of the gateway user plane services, a service composer configured to compose subsets of the plurality of service blocks for servicing UE requests, and at least one scheduler configured to apply one or more of the subsets of the plurality of service blocks for servicing the UE requests. As an option, the gateway user plane services may be further configured for adding one or more service blocks.

To this end, in some optional embodiments, one or more of the foregoing features of the aforementioned apparatus and/or method may be used to enable more flexible and scalable network service introduction. Specifically, the distributed data store may allow for distributed user planes for evolved packet core (EPC) architectures for supporting diverse traffic demands. Still yet, a service composition framework may be afforded to dynamically configure service nodes, as well as re-configure the same, as necessary. This may, in turn, result in simplified, cost-effective, and seamless gateway selection/construction that would otherwise be foregone in systems that lack the foregoing capabilities. It should be noted that the aforementioned potential advantages are set forth for illustrative purposes only and should not be construed as limiting in any manner.

### BRIEF DESCRIPTION OF THE DRAWINGS

FIG. 1 illustrates a distributed data store-equipped evolved packet core (EPC) system, in accordance with one embodiment.

FIG. 2 is a flow chart of a method for servicing user equipment (UE) requests using a distributed data store-equipped EPC system, in accordance with one embodiment.

FIG. 3 illustrates a distributed data store-equipped EPC system, in accordance with another embodiment.

FIG. 4 illustrates a composable service framework, in accordance with another embodiment.

FIG. 5 illustrates a distributed data store-equipped EPC system, in accordance with another embodiment.

FIG. 6 illustrates a network architecture, in accordance with one embodiment.

FIG. 7 illustrates an exemplary system, in accordance with one embodiment.

### DETAILED DESCRIPTION

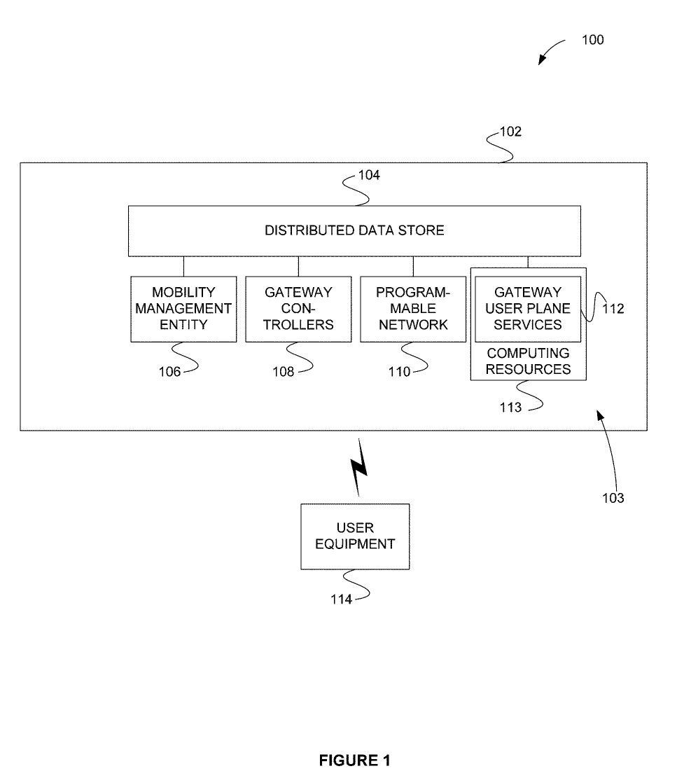

FIG. 1 illustrates a distributed data store-equipped evolved packet core (EPC) gateway system 100, in accordance with one embodiment. As shown, the system 100 includes an apparatus 102 including a distributed data store 104 in communication with a plurality of components 103 including, but not limited to a mobility management entity (MME) 106, gateway controllers 108, a programmable network 110, and gateway user plane services 112. As will become apparent, the distributed data store 104 is accessible via a plurality of (if not all) the foregoing components 103 to read/write (e.g. access/update, etc.) various information that enables the gateway controllers 108 to identify (e.g. select, construct, etc.) at least one gateway via the gateway user plane services 112 (and possibly even configure the programmable network 110) so as to flexibly accommodate different requests of different user equipment (UE) 114 that are received via the MME 106. More information will now be set forth regarding each of the foregoing components and the interoperation thereof.

It should be noted that, in various embodiments, each of the components 103 may include separate physical and/or logical components that may or may not be combined in any desired manner. For example, in one embodiment, one or more of the components 103 may include logical components that share the same underlying physical hardware resources (e.g. processors, processor cores, network components, etc.). In use, such logical components 103 may be configured to utilize different numbers, types, etc. of the hardware resources, so that the logical components 103 may be scaled in a flexible manner to accommodate different requests from the various UEs 114.

So that the aforementioned functionality may be carried out in an intelligent manner, the distributed data store 104 is configured to store various information to drive the selection/construction process. Specifically, the distributed data store 104 is configured to store UE information received from the MME 106, where the MME 106 receives such UE information from a home subscriber server (HSS) (not shown) and uses such information to update the distributed data store 104. In the context of the present description, the MME 106 may refer to any module that receives service requests directly or indirectly (e.g. via a base station) from the UE 114, and sends path selection/setup request messages to the gateway controllers 108 so that such path selection/setup requests may be fulfilled using the programmable network 110 and the gateway user plane services 112.

Further, the UE information may include any information associated with the UE 114 including, but not limited to a capability of the UE 114 (e.g. bandwidth, network-related, functional, throughput, service-specific capabilities, etc.), a type of the UE 114 (e.g. brand, model, etc.), a location of the UE (e.g. global positioning system coordinates, cell tower identifier, etc.), a quality of service associated with the service request (e.g. assigned per a service agreement, etc.), and/or a service associated with the service request (e.g. augmented reality (AR)/virtual reality (VR), video, etc.).

The distributed data store 104 is further configured to store gateway information that may include any information associated with the gateway user plane services 112 and/or underlying computing resources 113. In the context of the present description, such gateway user plane services 112 may provide any point(s) that serves as an entrance to another network (e.g. wide area network, Internet, etc.). For example, in one possible embodiment, the gateway user plane services 112 may take a form of a virtualized user plane hosted on the computing resources 113 which, in turn, may include any computing hardware including, but not limited to a plurality of gateways (e.g. gateway clusters, etc.). In such embodiment (that will be elaborated upon later during the description of subsequent figures), the virtualized user plane may include a plurality of service blocks that provide different services that run on the computing resources 113. To this end, the user plane may be separate and configurable from the underlying computing resources 113 (e.g. the gateway clusters, etc.), so that the user plane may be flexibly configured to use any one or more of the gateway clusters, as required during use.

Further, in various embodiments, the gateway information may include, but is not limited to a utilization of the gateway user plane services 112 and/or the underlying computing resources 113 (e.g. a current load, a maximum load, a load availability, etc.), and/or a capability of the gateway user plane services 112 and/or the underlying computing resources 113 (e.g. one or more services which are capable of being delivered/supported, etc.), physical/virtual resource information associated with the computing resources 113 which host the gateway user plane services 112, and/or a location of the gateway user plane services 112 and the underlying computing resources 113. In use in accordance with one possible embodiment, the gateway user plane services 112 and the underlying computing resources 113 may update the distributed data store 104 (e.g. periodically, using push/pull techniques, etc.) as conditions change, so that the distributed data store 104 includes updated gateway information.

In one optional embodiment, the distributed data store 104 may be further configured to store network information received from the programmable network 110. In the present description, the programmable network 110 may include any one or more physical and/or logical routers and/or switches that may be configured and re-configured for routing data from the UE 114 (via one or more base stations) to an appropriate gateway of the gateway user plane services 112. Further, while such network information may include any information associated with the programmable network 110, it may, in various embodiments, include a load of the programmable network 110 (e.g. a current load, a maximum load, a load availability, etc.), and/or a capability of the programmable network 110 (e.g. one or more services which are capable of being delivered/supported, etc.) that are similar to or different from the gateway information.

In another optional embodiment, the gateway controllers 108 may take the form of a software-defined network (SDN) controller platform where the gateway controllers 108 serve as SDN applications. In such embodiment, the various network information may be collected and stored by the SDN controller platform. To this end, the gateway controllers 108 may be implemented utilizing the aforementioned SDN controller platform which is configured to store the network information received from the programmable network 110. Further, the SDN controller platform may be further configured to program the programmable network 110 based on at least a portion of the network information, for use in servicing the service request for the UE 114 by routing communications between the UE 114 and the selected/constructed gateway(s).

So that the distributed data store 104 and the various information stored thereon may be effectively accessed during selection/construction of the gateway user plane services 112 and, in some embodiments, the configuration of the programmable network 110, the distributed data store 104 may include any store that is capable of storing at least a portion of the aforementioned information as multiple replicated instances. Further, such replicated instances may or may not be stored on or near any one or more (or all) of the aforementioned components 103. By this design, such information may be conveniently updated and/or accessed by one or more of the aforementioned components 103. Further, strictly as an option, the distributed data store 104 may use an error detection and correction technique, and/or use forward error correction techniques to recover original data (e.g. a file, etc.) when such data (or a portion thereof) is damaged or unavailable, so as to maintain data replication.

In use, the gateway controllers 108 are configured to receive a message from the MME 106 associated with a service request for the UE 114. In the context of the present description, such message may include any signaling that is caused or prompted by a request for service for the UE 114. Further, in response to the message, the distributed data store 104 is queried by the gateway controllers 108 for at least a portion of the UE information associated with the UE 114, and at least a portion of the gateway information. In various embodiments, such portion (or subset) of the UE/gateway information may be that portion which is relevant to the UE service request and/or resultant MME message. To this end, at least one gateway is identified using the gateway user plane services 112, based on the at least portion of the UE information and the at least portion of the gateway information, for use in servicing the UE service request.

In various embodiments, the at least one gateway of the gateway user plane services 112 may be identified in any desired manner that results in the at least one gateway being available to service the UE service request. For example, in one possible embodiment, the at least one gateway may be identified in connection with a selection thereof via the gateway user plane services 112. In such embodiment, the plurality of gateways of the gateway user plane services 112 may already be constructed and may (or may not) require some configuration before being ready for servicing the UE service request.

By this design, one or more gateways may host the same gateway user plane services 112, and an optimal gateway(s) may be selected for a given UE service request. Further, as an option, the at least one gateway may be selected based the service request, a utilization of the gateway user plane services 112, a utilization of the computing resources 113 which host the gateway user plane services 112, and/or a location of the gateway user plane services 112 and the computing resources 113 which host the gateway user plane services 112.

In another possible embodiment, the at least one gateway may be identified in connection with a construction of the at least one gateway using the gateway user plane services 112. In the context of an embodiment where the gateway user plane services 112 take a form of a virtualized user plane (including service blocks) implemented using a plurality of gateway clusters, the at least one gateway may be constructed by applying a subset of the service blocks of the gateway user plane services 112.

In one optional embodiment, the gateway controllers 108 may be further configured to query the distributed data store 104 for at least a portion of the network information, in response to the message. Still yet, the gateway controllers 108 may be further configured to program the programmable network 110 based on the at least portion of the network information. To this end, the programmable network 110 may be programmed for use in supporting the servicing of the UE service request, by routing communications between the UE 114 and the identified at least one gateway.

To this end, in some optional embodiments, one or more of the foregoing features may be used to enable more flexible and scalable network service introduction. Specifically, the distributed data store may allow for distributed user planes for EPC architectures for supporting diverse traffic demands. Still yet, a service composition framework may be afforded to dynamically configure service nodes, as well as re-configure the same, as necessary. This may, in turn, result in simplified, cost-effective, and seamless gateway selection/construction that would otherwise be foregone in systems that lack the foregoing capabilities. It should be noted that the aforementioned potential advantages are set forth for illustrative purposes only and should not be construed as limiting in any manner.

More illustrative information will now be set forth regarding various optional architectures and uses in which the foregoing method may or may not be implemented, per the desires of the user. Any of the following features may be optionally incorporated with or without the other features described.

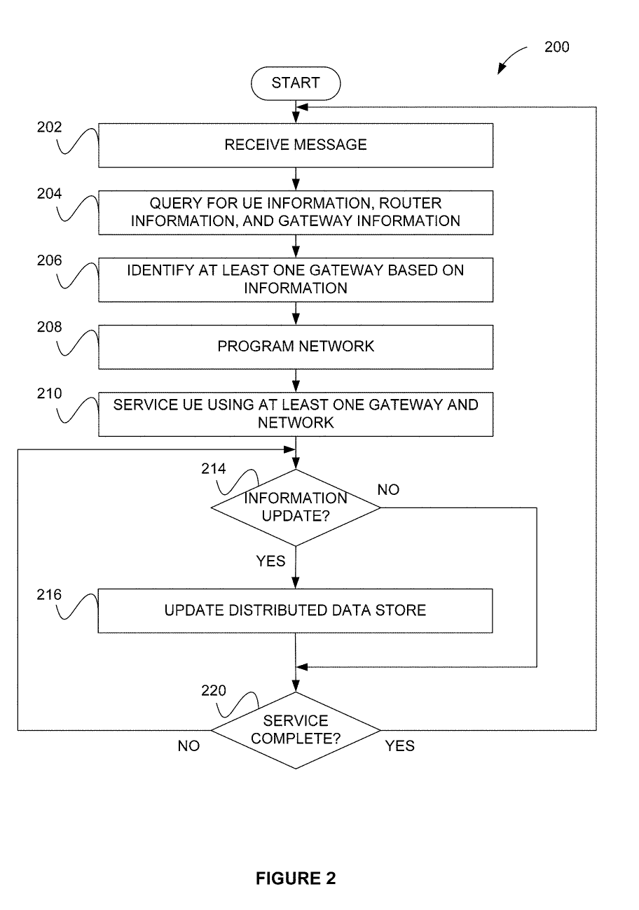

FIG. 2 is a flow chart of a method 200 for servicing UE requests using a distributed data store-equipped EPC system, in accordance with one embodiment. As an option, the method 200 may be implemented in the context of any one or more of the embodiments set forth in any previous and/or subsequent figure(s) and/or description thereof. For example, the method 200 may be implemented in the context of the system 100 of FIG. 1. However, it is to be appreciated that the method 200 may be implemented in the context of any desired environment.

As shown, at step 202, a message is received at gateway controllers (e.g. the gateway controllers 108 of FIG. 1, etc.) from a MME (e.g. the MME 106 of FIG. 1, etc.). Such message may be received in response to a service request for a UE which, in turn, may be received by the MME via one or more base stations. In one possible embodiment, the aforementioned message may include a S1-AP UE init message that is received in accordance with the S1 Application Protocol (S1AP) that defines the signaling service protocol between Radio Access Networks (RAN) and the EPC.

In one optional embodiment, the gateway controllers may be further configured for being addressable utilizing a single virtual Internet Protocol (IP) address. In one embodiment, such addressing may be carried out by the MME. By this design, the MME may conveniently address all (or nearly all) of the foregoing messages to a single destination. Based on load information associated with the gateway controllers, the messages are forwarded to the desired gateway controller by the network. As will soon become apparent, the gateway controllers may then select and/or construct the necessary gateway(s) for servicing the UE service request.

In response to the message, in step 204, the gateway controller queries a distributed data store (e.g. the distributed data store 104 of FIG. 1, etc.) for UE information, network information if it is presented in the distributed data store, and/or gateway information. As mentioned earlier, such query may (or may not) be tailored to the particular message and, thus, the request from the MME for the UE service request and/or the UE that prompted the same. For example, the gateway controller may glean, directly from the message and/or through a specific UE-related query to the distributed data store, a UE capability, a UE type, a UE location, a service request-related quality of service, and/or a particular service. By this design, the aforementioned query(ies) may be tailored and/or directed to gateway information (and possibly network information) of particular gateway/programmable network (or a portion thereof) that would be capable of accommodating such features.

In any case, at step 206, at least one gateway is identified based on such queried information. As mentioned earlier, step 206 may be carried out in the context of the selection of an already-constructed gateway(s) among a plurality of such gateways, and/or the construction of a new gateway(s). Further, in one possible embodiment, the identification may involve, after the aforementioned selection/construction, the production of an address or other identifier that may be used to identify and use the appropriate gateway(s) in operation. In any case, the gateway(s) may be identified in any desired manner that optimally matches service needs of the UE and/or associated service request, with capabilities/availability of the gateway user plane services/programmable network.

Just by way of example, a specific type of service requested by the UE may result in a particular gateway(s) to be selected since such gateway(s) supports such specific type of service. In yet another example, a required bandwidth or other capability of the UE services may dictate which gateway(s) is identified for servicing the such UE (based on matching bandwidth/capabilities of the gateway(s)). In still yet another example, a quality of service threshold of a requesting UE may result in a particular gateway(s) to be selected since such gateway(s) is capable of delivering such quality of service threshold based on current load requirements. In additional embodiments, the gateway identification may be a function of any combination of any one or more of the UE/gateway(s) information (and possibly even the programmable network information). Of course, these examples are set forth for illustrative purposes only and should not be construed as limiting in any manner.

Further, once the gateway(s) is identified, a programmable network (e.g. the programmable network 110 of FIG. 1, etc.) may be programmed in step 208, so that data may be communicated between the UE that initiated the service request, and the gateway(s) identified in step 206. In one optional embodiment, such programming may be accomplished by selecting and/or constructing a plurality of network routers in a manner that permits the aforementioned routing. Further, such programming of the programmable network may be based on any of the aforementioned queried information.

For example, the programmable network may be specifically programmed to accommodate specific disparate locations of the UE and identified gateway(s). As another example, the programmable network may be programmed to accommodate a capability/throughput expectation on the part of the UE. In still yet another embodiment, the programmable network may be programmed based simply on its own current load status. In additional embodiments, the programming of the programmable network may be a function of any combination of any one or more of the UE/gateway(s)/programmable network information. Again, these examples are set forth for illustrative purposes only and should not be construed as limiting in any manner.

Thus, in step 210, the UE may be serviced using the identified gateway(s) and programmed network. Specifically, data communicated between (e.g. to and/or from) the UE and its destination may be routed through the programmed network to the identified gateway(s) before being sent over a network to the destination.

Further, while such servicing is taking place, it may be determined in decision 214 whether any updated information (e.g. UE/gateway(s)/network information, etc.) exists. If so, such updated information may be populated, in step 216, in the distributed data store, so that the information is up-to-date for future iterations of operations 202-210. As mentioned earlier, steps 214-216 may be prompted by any periodic population technique, push/pull mechanism, or any other technique that updates the information in the distributed data store.

To this end, absent a gateway user plane service failure or some other load balancing mandate (that would interrupt service), the UE is serviced until complete per decision 220, and the method 200 may be repeated for additional messages. More information will now be set forth regarding one possible exemplary use case by which the method 200 may be implemented.

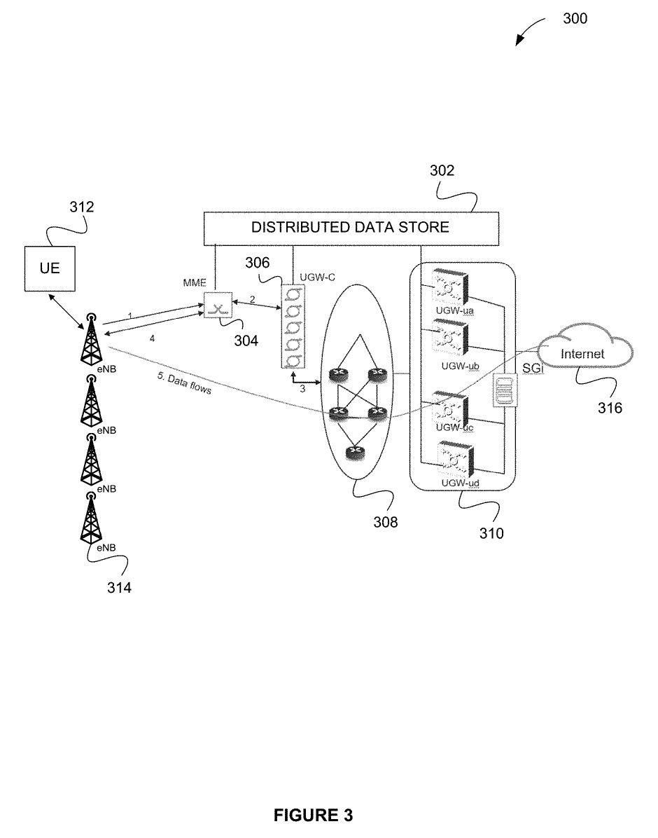

FIG. 3 illustrates a distributed data store-equipped EPC system 300, in accordance with another embodiment. As an option, the system 300 may be implemented in the context of any one or more of the embodiments set forth in any previous and/or subsequent figure(s) and/or description thereof. However, it is to be appreciated that the system 300 may be implemented in the context of any desired environment.

As shown, the distributed data store-equipped EPC system 300 includes a distributed data store 302 in communication with a MME 304, gateway controllers 306, a programmable network 308, and gateway user plane services 310 in the form of a plurality of distributed and virtualized user plane gateway clusters (UGW-ua, UGW-ub, UGW-uc, UGW-ud, etc.). A UGW-manager (not shown) may be responsible for creating, deleting, modifying, and/or configuring each UGW based on either EPC network demands and/or input from a network operator. In the one embodiment, the MME 304 may be responsible for mobility management, as it interacts with, for example, a Home Subscriber Server (HSS) module, a Policy and Charging Rules Function (PCRF) module, a Domain Name System (DNS) module (all not shown) to authenticate each UE and obtain UE context and UE service characteristics so that such information may be stored and shared via the distributed data store 302.

In use, the distributed data store-equipped EPC system 300 enables read/write capabilities for UE context information, UE location information, network element capability information, load status information, computing nodes resource information, hardware capabilities, etc. By this design, each of the above network element components of the system 300 may have access to knowledge shared by other network elements, and thus provide better performance.

Further, the above components of the system 300 cooperate to service a UE 312 that communicates with the system 300 via a plurality of base stations 314, and to enable communication between the UE 312 and a destination over a network (e.g. the Internet, etc.) A specific use case will now be set forth detailing an interaction among the various components of the system 300.

As shown, in step 1 after the UE 312 attaches to one of the base station 314, such base station 314 sends a S1AP UE init message to the MME 304, the MME 304 interacts with an HSS, Policy and Charging Rules Function (PCRF), etc. to obtain UE information, such as capabilities, supported service type, etc., and the MME 304 writes UE specific information (e.g. service requirements, et.) to the distributed data store 302. Next, in step 2, session create messages are exchanged between the MME 304 and the gateway controllers 306. Further, the gateway controllers 306 identify, in step 3, at least one gateway by performing a gateway selection process based on information shared through the distributed data store 302. Resulting from this selection process is at least one gateway of the gateway user plane services 310 that is selected for UE services.

Also in connection with step 3, the gateway controllers 306 program the underlying programmable network 308 to ensure that data is sent to the selected gateway of the gateway user plane services 310. In one optional embodiment, Openflow may be used to program the programmable network 308. As mentioned earlier, the gateway controllers 306 may be further configured for being addressable by the MME 304 utilizing a single virtual IP address. Based on load information associated with the gateway controllers 306, the messages are forwarded to the desired gateway controller 306 by the network. In such embodiment, data flow may be addressed to the gateway clusters of the gateway user plane services 310 using the same virtual IP address. To differentiate data flows, such flows may be assigned tunnel endpoint identifiers (TEIDs), in one embodiment.

In step 4, the initial context setup is complete between the MME 304 and one of the base station 314. To this end, data flow is sent out from the base station 314 to the selected gateway of the gateway user plane services 310 via the pre-programmed network 308.

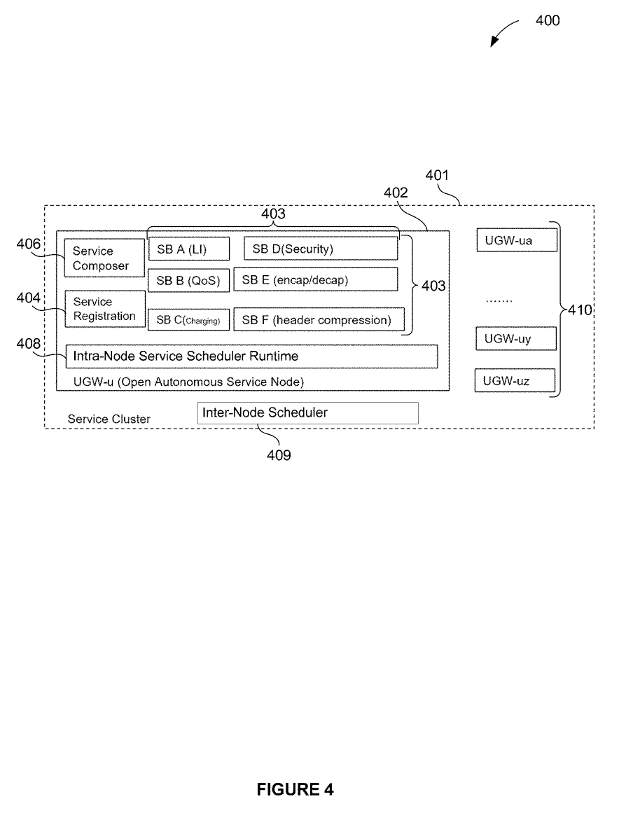

FIG. 4 illustrates a composable service framework 400, in accordance with another embodiment. As an option, the service framework 400 may be implemented in the context of any one or more of the embodiments set forth in any previous and/or subsequent figure(s) and/or description thereof. For example, in one embodiment, the service framework 400 may be implemented in the context of the gateway user plane services 112 of FIG. 1, the gateway user plane services 310 of FIG. 3, etc. However, it is to be appreciated that the service framework 400 may be implemented in the context of any desired environment.

As shown, the service framework 400 includes gateway user plane services including at least one gateway framework 402 that takes the form of software running on a plurality gateway clusters 410 (e.g. UGW-u's). Such gateway framework 402 of the service framework 400, in turn, includes a plurality of service blocks 403 that each include code and/or data structures that define different services that may be configured and applied during execution. Examples of such service blocks 403 may include, but are not limited to a lawful interception (LI) service block, quality of service service block, a security service block, an encapsulation/decapsulation service block, a header compression service block, a charging service block, etc.

With continuing reference to FIG. 4, the gateway framework 402 further includes a service registration module 404 configured to register a plurality of the service blocks 403 of the gateway user plane services. Also included is a service composer 406 configured to compose subsets of the service blocks 403 for servicing a UE. In various embodiments, the service registration module 404 and/or the service composer 406 may include an agent that accepts commands from a UGW manager to add (e.g. import, create, or otherwise provide/configure, etc.) the service blocks 403 and/or subsets thereof. The UGW manager includes a graphical user interface (GUI) to allow users to send commands to configure service blocks 403 and/or subsets thereof. In other embodiments, the service registration module 404 and/or the service composer 406 may include other more automated interfaces (e.g. an import interface that simply imports the service blocks 403 and/or subsets thereof).

Also included as a component of the gateway framework 402 is at least one intra-node scheduler 408 configured to apply one or more of the subsets of the plurality of service blocks 403 for servicing a UE. The intra-node scheduler 408 may include any logic that is capable of applying appropriate service blocks 403 and/or subsets thereof. The gateway framework 402 may optionally include at least one inter-node scheduler 409 configured to manage any cooperation between different gateways/clusters.

To this end, the service framework 400 disaggregates an overall service into the separate service blocks 403. Further, the service composer 406 may serve to create a service block chain for incoming packets. For instance, a particular one of the gateway clusters 410 may run only necessary disaggregated functions, such as service blocks B, D, E (that are shown in FIG. 4). At runtime, the intra-node scheduler 408 may then create a service worker thread that iterates and runs through the relevant functions for incoming requests.

In one possible embodiment, a UGW-u manager (embodied in software) may be included which is responsible for creating, deleting, scaling-up/down, etc. the aforementioned UGW-u's. Such UGW-u manager may also be responsible for provisioning/configuring services inside the gateways. Still yet, the uGW-u manager may also expose a GUI to allow operators to import, create, and/or configure the service blocks 403 for given gateways, and/or it may automatically scale up/down UGW-u's which host certain types of services based on network dynamics. In one optional embodiment, the services inside a given gateway may not necessarily change per UE request, but are reconfigured via the aforementioned GUI.

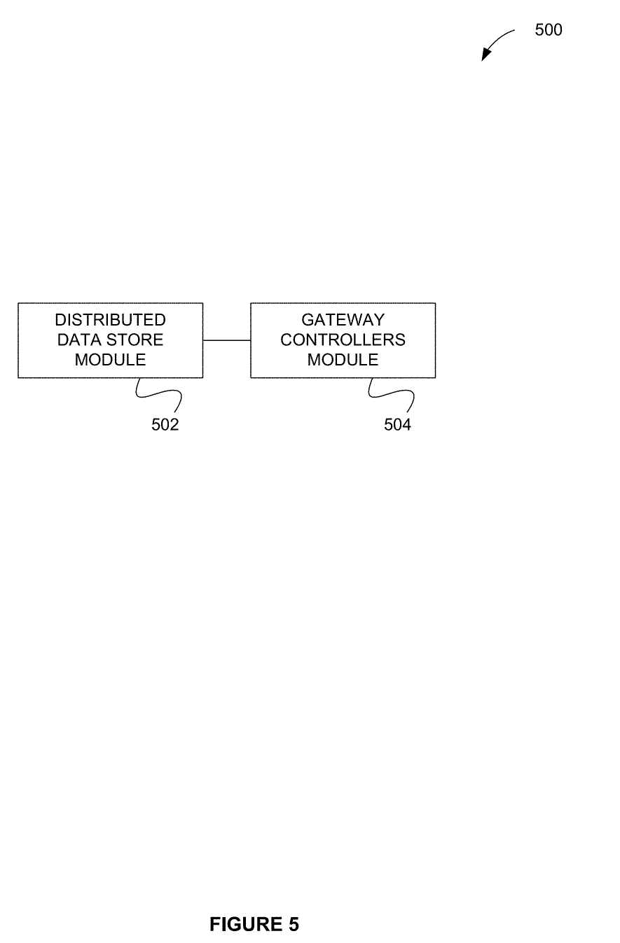

FIG. 5 illustrates a distributed data store-equipped gateway system 500, in accordance with another embodiment. As an option, the system 500 may be implemented with one or more features of any one or more of the embodiments set forth in any previous and/or subsequent figure(s) and/or the description thereof. However, it is to be appreciated that the system 500 may be implemented in the context of any desired environment.

As shown, a distributed data store means in the form of a distributed data store module 502 is provided for storing the various information set forth earlier (e.g. the UE/gateway/network information, etc.). In various embodiments, the distributed data store module 502 may include, but is not limited to the distributed data store 104 of FIG. 1, the distributed data store 302 of FIG. 3, at least one memory (to be described later) and any software controlling the same, and/or any other circuitry capable of the aforementioned functionality.

Also included is gateway controllers means in the form of a gateway controllers module 504 in communication with the distributed data store module 502 for receiving, from a MME, a message associated with a service request for a UE; querying the distributed data store module 502 for at least a portion of UE information associated with the UE, and at least a portion of the gateway information; and identifying at least one gateway, based on the at least portion of the UE information and the at least portion of the gateway information, for use in servicing the service request for the UE. In various embodiments, the gateway controllers module 504 may include, but is not limited to the gateway controllers 108 of FIG. 1, the gateway controllers 306 of FIG. 3, at least one processor (to be described later) and any software controlling the same, and/or any other circuitry capable of the aforementioned functionality.

By this design, a service composition framework is afforded to dynamically configure service nodes. Further, in some optional embodiments, a distributed data store platform may be provided to possibly: support intelligent traffic switching/routing for next generation mobile network cores for real time mobile network dynamics, enable distributed user planes, and provide better opportunities for network scaling and elasticity. Such mechanisms may further support distributed user planes to meet diverse traffic requirements, and enable load balancing and network slicing in an EPC. Still yet, a virtual IP addressing technique may optionally be applied to distributed mobile gateways to simplify network operations.

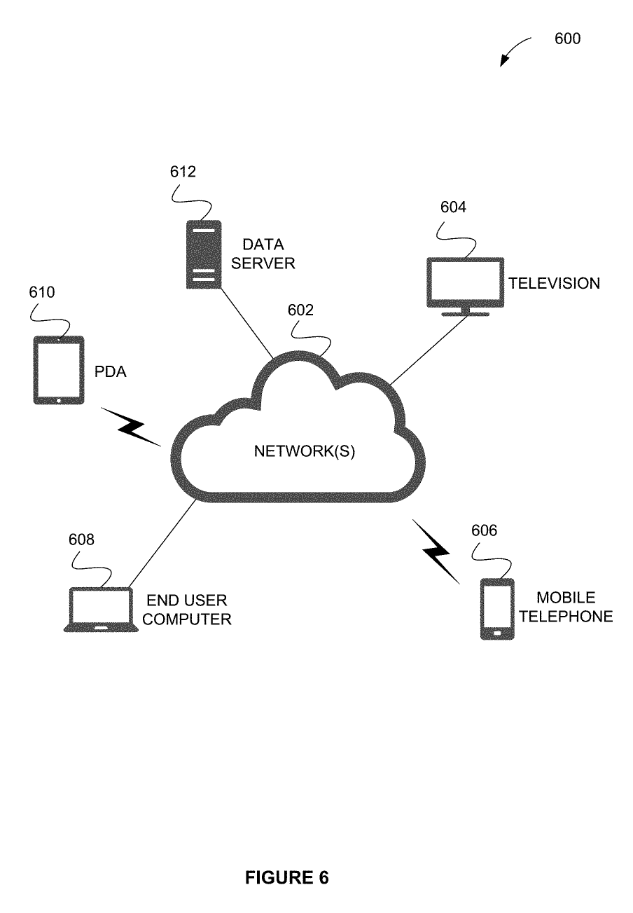

FIG. 6 illustrates a network architecture 600, in accordance with one embodiment. As shown, at least one network 602 is provided. In various embodiments, any one or more components/features set forth during the description of any previous figure(s) may be implemented in connection with any one or more of the components of the at least one network 602.

In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

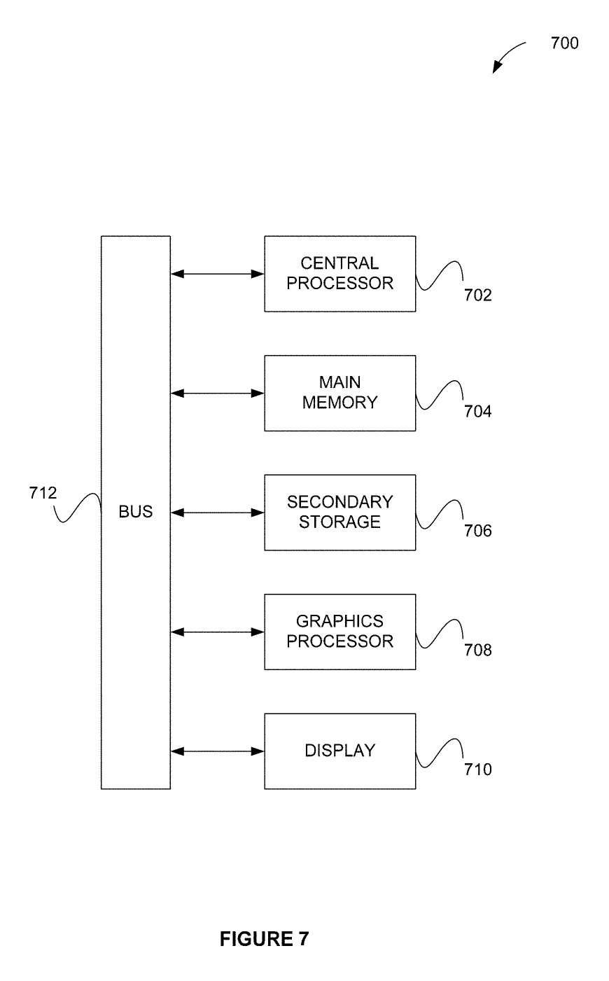

FIG. 7 illustrates an exemplary system 700, in accordance with one embodiment. As an option, the system 700 may be implemented in the context of any of the devices of the network architecture 600 of FIG. 6. However, it is to be appreciated that the system 700 may be implemented in any desired environment.

As shown, a system 700 is provided including at least one processor 702 which is connected to a bus 712. The system 700 also includes memory 704 [e.g., hard disk drive, solid state drive, random access memory (RAM), etc.]. The memory 704 may include one or more memory components, and may even include different types of memory. In one embodiment, the memory 704 may be used to implement the distributed data store module 502 of FIG. 5. The system 700 also includes a display 710 in the form of a touchscreen, separate display, or the like. Further included is a network interface 708. In one embodiment, the network interface 708 may be used to implement the gateway controllers module 504 of FIG. 5.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 704, the secondary storage 706, and/or any other memory, for that matter. Such computer programs, when executed, enable the system 700 to perform various functions (as set forth above, for example). Memory 704, secondary storage 706 and/or any other storage comprise non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An apparatus, comprising:
a distributed data store configured to store user equipment information received from a mobility management entity, and gateway information received from a plurality of gateway user plane services and computing resources; and
a plurality of gateway controllers in communication with the distributed data store, wherein the plurality of gateway controllers are configured to:
receive a message from the mobility management entity associated with a service request for a user equipment;
in response to the message, query the distributed data store for at least a portion of the user equipment information, and at least a portion of the gateway information; and
identify at least one gateway using the gateway user plane services, based on the at least portion of the user equipment information and the at least portion of the gateway information, for use in servicing the service request for the user equipment.

2. The apparatus of claim 1, wherein the distributed data store is further configured to store network information received from a programmable network, and the plurality of gateway controllers are further configured to:
in response to the message, query the distributed data store for at least a portion of the network information;
program the programmable network based on the at least portion of the network information; and
route communications between the user equipment and the at least one gateway.

3. The apparatus of claim 1, wherein the plurality of gateway controllers are implemented utilizing a software-defined network (SDN) controller platform that is further configured to store network information received from a programmable network, and the SDN controller platform is further configured to program the programmable network based on at least a portion of the network information, and route communications between the user equipment and the at least one gateway.

4. The apparatus of claim 1, wherein the plurality of gateway controllers are further configured for being addressable utilizing a single virtual Internet Protocol (IP) address.

5. The apparatus of claim 1, wherein the message is received by one or more of the plurality of gateway controllers based on a load of the one or more of the plurality of gateway controllers.

6. The apparatus of claim 1, wherein the apparatus is further configured to update the distributed data store.

7. The apparatus of claim 1, wherein the plurality of gateway controllers is configured to identify the at least one gateway via the gateway user plane services with a virtualized user plane implemented using a plurality of gateway clusters.

8. The apparatus of claim 7, wherein the at least one gateway is selected based on at least one of the service request, a utilization of the gateway user plane services, a utilization of the computing resources, and a location of the gateway user plane services.

9. The apparatus of claim 1, wherein the gateway user plane services include:
a service registration module configured to register a plurality of service blocks of the gateway user plane services;
a service composer configured to compose subsets of the plurality of service blocks for servicing user equipment requests; and
at least one scheduler configured to apply one or more of the subsets of the plurality of service blocks for servicing the user equipment requests.

10. A method, comprising:
storing, by a distributed data store, user equipment information received from a mobility management entity;
storing, by the distributed data store, gateway information received from a plurality of gateway user plane services and computing resources;
receiving, at one or more gateway controllers, a message from the mobility management entity associated with a service request for a user equipment;
in response to the message, querying, by the one or more gateway controllers, the distributed data store for at least a portion of the user equipment information and at least a portion of the gateway information; and
identifying, by the one or more gateway controllers, at least one gateway in connection with the gateway user plane services, based on the at least portion of the user equipment information and the at least portion of the gateway information, for use in servicing the service request for the user equipment.

11. The method of claim 10, and further comprising:
storing, in the distributed data store, network information received from a programmable network;
in response to the message, querying the distributed data store, by the one or more gateway controllers, for at least a portion of the network information;
programming, by the one or more gateway controllers, the programmable network based on the at least portion of the network information; and
routing, by the one or more gateway controllers, communications between the user equipment and the at least one gateway.

12. The method of claim 10, wherein the one or more gateway controllers are implemented utilizing a software-defined network (SDN) controller platform that is further configured to store network information received from a programmable network, and further comprising:
programming the programmable network based on at least a portion of the network information; and
routing communications between the user equipment and the at least one gateway.

13. The method of claim 10, wherein the one or more gateway controllers are further configured for being addressable utilizing a single virtual Internet Protocol (IP) address.

14. The method of claim 10, wherein the identifying is performed via the gateway user plane services with a virtualized user plane implemented using a plurality of gateway clusters.

15. The method of claim 10, further comprising:
updating at least one of the user equipment information and the gateway information stored in the distributed data store.

16. An apparatus, comprising:
a non-transitory memory storage comprising instructions; and
one or more processors in communication with the memory storage, wherein the one or more processors execute the instructions to:
store user equipment information received from a mobility management entity;
store gateway information received from a plurality of gateway user plane services and computing resources;
receive a message from the mobility management entity associated with a service request for a user equipment;
in response to the message, query the distributed data store for at least a portion of the user equipment information and at least a portion of the gateway information; and
identify at least one gateway in connection with the gateway user plane services, based on the at least portion of the user equipment information and the at least portion of the gateway information, for use in servicing the service request for the user equipment.

17. The apparatus of claim 16, wherein the one or more processors further execute the instructions to:
update at least one of the user equipment information and the gateway information.

18. The apparatus of claim 16, wherein the one or more processors further execute the instructions to:
register a plurality of service blocks of the gateway user plane services;
compose subsets of the plurality of service blocks for servicing user equipment requests; and
apply one or more of the subsets of the plurality of service blocks for servicing the user equipment requests.

19. The apparatus of claim 16, wherein the one or more processors further execute the instructions to:
identify a single virtual IP address for the at least one gateway.

20. The apparatus of claim 16, wherein the instruction to identify the at least one gateway is to identify the at least one gateway via the gateway user plane services with a virtualized user plane implemented using a plurality of gateway clusters.
